(19) United States
(12) Patent Application Publication
(10) Pub. No.: US 2009/0144513 A1
(43) Pub. Date: Jun. 4, 2009

(54) DATABASE UPDATE METHOD

(75) Inventors: Jeffrey D. Pierce, Sandy Hook, CT (US); Thomas J. Foth, Trumbull, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Inc., Stamford, CT (US)

(21) Appl. No.: 11/949,188

(22) Filed: Dec. 3, 2007

(51) Int. Cl. G06F 12/00; G06F 17/30

(52) U.S. Cl. 711/159; 707/6; 707/E17.041; 711/E12.069

(57) ABSTRACT

According to some embodiments a system and a method are provided to storing a plurality of data, the data comprising a plurality of original data elements and corresponding modified data elements. The plurality of original data elements may be automatically compared against editable field data in one or more editable fields that are displayed on a display screen by an application program. A determination may be made if the editable field data will be replaced and the editable field data may be replaced with the corresponding modified data elements if a determination is made to replace the editable field data.

### BACKGROUND

Changes happen in almost every aspect of a person's life. For example, a person may move, switch employers, change service providers such as banks and/or investment firms, and may switch email providers. Data associated with an individual may change as the individual moves, switches jobs, changes service providers, or switches email providers. For example, when a person switches email providers his/her email address may change (e.g. a change in domain name) and when a person moves, his or her address may change.

Since a plurality of databases store an individual's data, and the plurality of databases are not automatically updated every time a change occurs, if incorrect data remains stored even in a single database, such as, but not limited to, a financial institution or an investment firm, an individual may not receive statements or other notices sent by the financial institution or investment firm.

### SUMMARY

In one embodiment a method is directed to storing a plurality of data, the data comprising a plurality of original data elements and corresponding modified data elements. The plurality of original data elements may be automatically compared against editable field data in one or more editable fields that are displayed on a display screen by an application program. A determination may be made if the editable field data will be replaced and the editable field data may be replaced with the corresponding modified data elements if a determination is made to replace the editable field data.

A system is also disclosed. The system may include a processor and a computer readable medium. The computer readable medium may comprise instructions that when executed by the processor performs a method. The method may comprise storing a plurality of data, the data comprising a plurality of original data elements and corresponding modified data elements. The plurality of original data elements may be automatically compared against editable field data in one or more editable fields that are displayed on a display screen by an application program. A determination is made if the editable field data will be replaced and the editable field data may be replaced with the corresponding modified data elements if a determination is made to replace the editable field data.

In one embodiment, a method is directed to storing a plurality of address data elements, the data elements comprising an original street address, a modified street address, an original city, a modified city, an original state, a modified state, an original zip code, and a modified zip code.

Each original address data element may be automatically compared against editable field address data in one or more editable address fields displayed on a display screen by an application program. The comparing may comprise comparing the original street address with an editable field address data, comparing the original city with an editable field city data, comparing the original state with an editable field state data, and comparing the original zip code with an editable field zip code data. The method discloses determining if the editable field address data will be replaced with the modified address data elements, where the determining comprises determining if the original street address matches an editable field address data, determining if the original city matches an editable field city data, determining if the original state matches an editable field state data, and determining if the original zip code matches an editable field zip code data. The editable field address data may be replaced with the corresponding modified address elements if a determination is made to replace the editable field data. The replacing may comprise replacing the editable field address data if the original street address matches an editable field address data, replacing the editable field city data if the original city matches an editable field city data, replacing the editable field state data if the original state matches an editable field state data, and replacing the editable field zip code data if the original zip code matches an editable field zip code data.

Therefore, it should now be apparent that the invention substantially achieves all the above aspects and advantages. Additional aspects and advantages of the invention will be set forth in the description that follows, and in part will be obvious from the description, or may be learned by practice of the invention. Various features and embodiments are further described in the following figures, descriptions, and claims.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 illustrates a system according to some embodiments.

FIG. 2 illustrates a method according to some embodiments.

FIG. 3 illustrates a method according to some embodiments.

FIG. 4 illustrates a data entry screen according to some embodiments.

FIG. 5 illustrates a data entry screen according to some embodiments.

### DETAILED DESCRIPTION

The several embodiments described herein are provided solely for the purpose of illustration. Embodiments may include any currently or hereafter-known versions of the elements described herein. Therefore, persons in the art will recognize from this description that other embodiments may be practiced with various modifications and alterations.

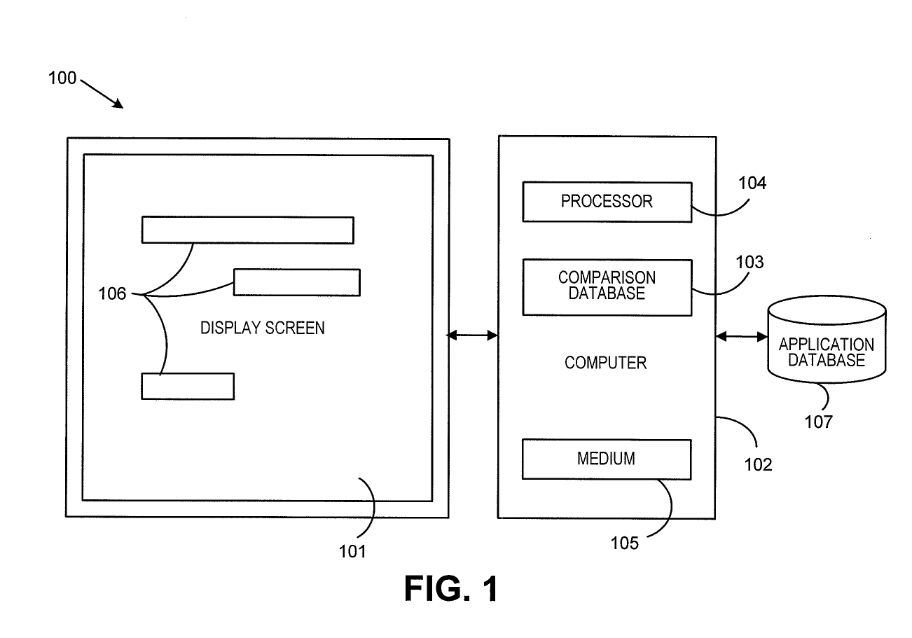

Now referring to FIG. 1, an embodiment of a system 100 is illustrated. The system 100 may comprise a display screen 101 and a computer 102. The computer 102 may be, but is not limited to, a mobile phone, a personal data assistant, a laptop, a desktop, or a server. In some embodiments, the computer 102 may comprise a comparison database 103, a processor 104, and a medium 105 to store instructions. The display screen 101 may be any known display screen such as, but not limited to, a plasma screen or a personal data assistant screen.

The computer 102 may execute an application, such as, but not limited to a web browser, where the application comprises a plurality of editable fields 106. The editable fields 106 of the application may be displayed on the display screen 101 and a user may enter data into the editable fields 106 such as address information, email address, and other personal information. When submitted, data entered into the editable fields may be inserted into an application database 107 or may update existing records in the application database 107.

The comparison database 103 may comprise any database that is, or becomes known. In some embodiments, the comparison database 103 may comprise a flat file, a linked list, a multi-dimensional array, or any know data structure. In some embodiment the comparison database 103 may be populated via a graphical user interface or by a manual SQL INSERT command as known in the art. In one embodiment, the comparison database 103 may be automatically updated via a mailing program that compares a list of mailing addresses to a national change of address list and corrects the list of mailing addresses for purposes of printing mailing labels.

The comparison database 103 may store a plurality of original data elements and a plurality of modified data elements. An original data element may be, but is not limited to, a street address, a city, a state, a zip code, an email address, a house number, an apartment number, or a post office box. A modified data element may be a corrected version of an original data element. For example, a person may currently live at 43 Main Street but had recently moved from 16 Park Avenue. In this case, 16 Park Avenue may be the original data element and 43 Main Street may be the modified data element. In a second example, a person may have accepted a job from a new employer and his/her email address may have changed from JohnDoe@Company_{—}1 to JohnDoe@Company_{—}2. In this example, JohnDoe@Company_{—}1 may be the original data element and JohnDoe@Company_{—}2 may be the modified data element. In a third example, the original data element may be the word AVENUE and the modified data element may be the term AVE. In some embodiments, the comparison database 103 may be external to the computer 102.

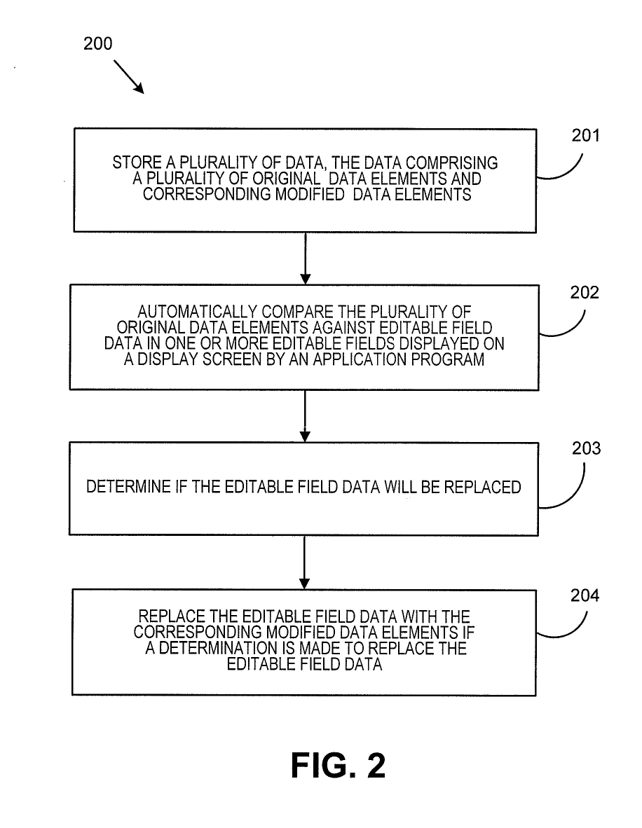

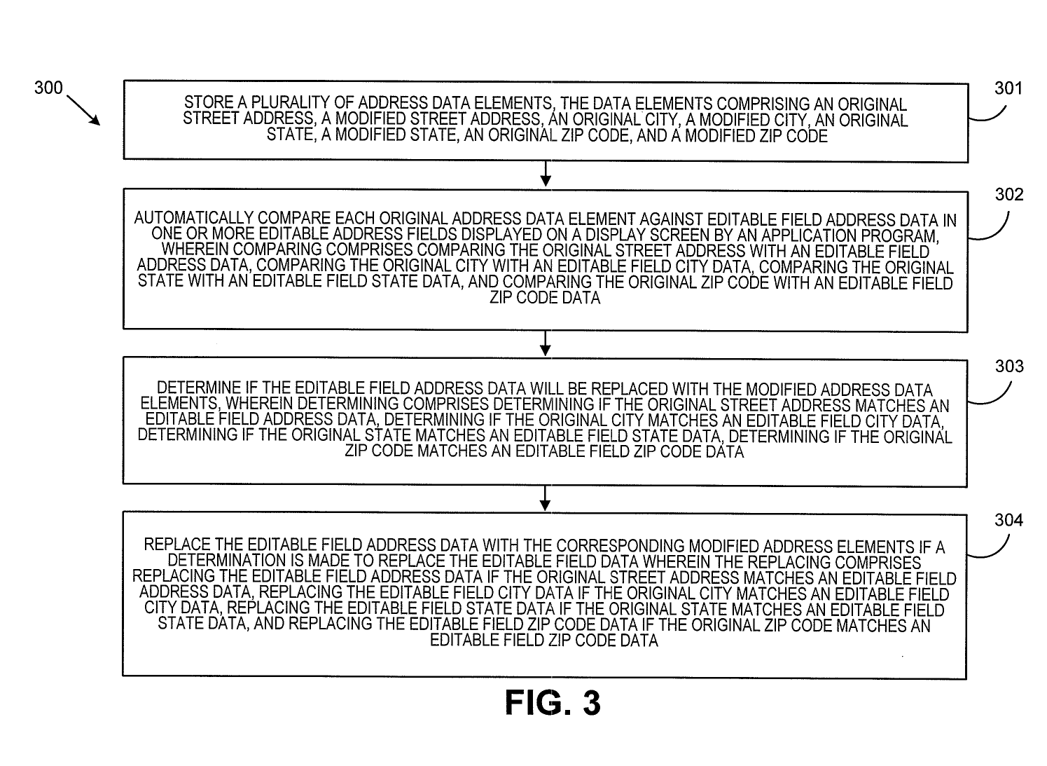

The medium 105 may be readable by a computer, or computer processor such as processor 104. The processor 104 may be any processor that is, or will be known. The medium 105 may comprise instructions that when executed by the processor, perform a method. The method may be any method, including but not limited to the methods of FIG. 2 and FIG. 3.

Now referring to FIG. 2, an embodiment of a method 200 is illustrated. The method 200 may be executed by any combination of hardware, software, and firmware, including but not limited to, the system 100 of FIG. 1. In some embodiments, a web browser tool bar may include an option to execute the method 200. The tool bar may be in a fixed position or may be dragged by a user to a more convenient location on a display. In some embodiments, the method may be executed by an application programming interface (“API”) that may run as part of an operating system, as part of an application or tool bar, or as a separate application.

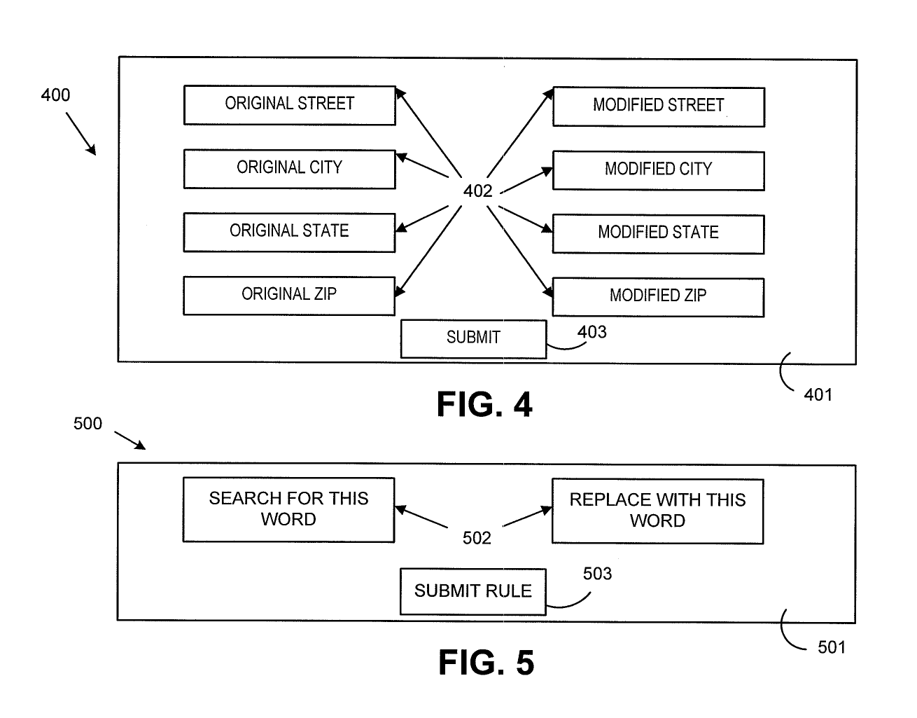

At 201 a plurality of data is stored, the data comprising a plurality of original data elements and corresponding modified data elements. The data may be stored in a relational database, a flat file, a linked list, a multi-dimensional array, or any known data structure. The original data elements and the modified data elements may be stored via a graphical user interface that comprises a plurality of editable data fields such as those illustrated in FIG. 4 and FIG. 5. In some embodiments, the original data elements may comprise incorrect address data and the modified data elements comprise corrected address data.

For illustrative purposes, and to aid in understanding features of the invention, an example will now be introduced. This example will be carried through the detailed description and this example is not intended to limit the scope of the invention.

A man may move from First Street, Hartford, Conn. to Second Avenue, Stamford, Conn. and will therefore have a new mailing address. The man may also maintain a bank account and an account at an investment firm. The man may enter his address into a database with First Street as an original address, Second Avenue as a corresponding modified address, Hartford as an original city, and Stamford as a corresponding modified city.

Next at 202, the plurality of original data elements are automatically compared against editable field data in one or more editable fields displayed on a display screen by an application program. The application program may be any program that has screen editable fields that when populated and submitted, update a database. In some embodiments the application program may be a web browser.

Continuing with the above example, the man may log into his bank account via a web browser over the internet and may view personal user information displayed on a personal information web page that his bank maintains for his bank account. The personal information web page may display the person's original address (e.g. First Street, Hartford, Conn.) and when the original address is displayed, an API may compare the original address data with the original data elements stored in a database.

Next at 203, a determination is made if the editable field data will be replaced. In some embodiments, the determining may comprise comparing the editable field data with the plurality of original data elements and determining that the editable field data includes original data elements that will be replaced by modified elements. In one embodiment the determination may be an automatic determination and, in this case, editable field data may automatically be replaced with modified data. In some embodiments, the determination may require a confirmation from a user. For example, if a determination is made to replace editable field data with modified data, a user may be prompted to confirm the determination. The user prompt may require the user to press a specific key on a keyboard or click on a portion of a graphic user interface window to confirm the determination.

Continuing with the above example, if the address fields displayed in the Bank's personal information web page (e.g. editable fields) match the original data elements then a determination may be made to replace the address displayed in the Bank's personal information web page with the modified data elements. In one embodiment, the user may be prompted with a pop-up box that asks the user to confirm the replacement.

In some embodiments, the comparison may be based on one or more rules stored in a database. Rule manipulated data may be data that can be located in a plurality of editable fields where an executed rule may globally change editable field data in the editable fields. For example, it may be a postal service preference to use a term of AVE instead of the word Avenue. Thus, every editable field may be searched for Avenue and the word Avenue may be replaced with rule manipulated data such as the term AVE.

Next at 204, the editable field data is replaced with the corresponding modified data elements if a determination is made to replace the editable field data.

Continuing with the above example, the address displayed in the Bank's personal information web page for the user is replaced with modified data elements. The bank database is updated with a corrected address associated with the man. Automatically correcting address information may improve delivery of mail pieces.

Now referring to FIG. 3, an embodiment of a method 300 is illustrated. At 301, a plurality of address data elements are stored, the data elements comprising an original street address, a modified street address, an original city, a modified city, an original state, a modified state, an original zip code, and a modified zip code. In some embodiments, an original country, a modified country, an original email address, a modified email address, an original telephone number, and a modified phone number may be stored.

Next, at 302, each original address data element may be automatically compared against editable field address data in one or more editable address fields displayed on a display screen by an application program, where the comparing comprises comparing the original street address with an editable field address data, comparing the original city with an editable field city data, comparing the original state with an editable field state data, and comparing the original zip code with an editable field zip code data.

At 303, a determination is made if the editable field address data will be replaced with the modified address data elements, where the determining comprises determining if the original street address matches an editable field address data, determining if the original city matches an editable field city data, determining if the original state matches an editable field state data, and determining if the original zip code matches an editable field zip code data.

At 304, the editable field address data is replaced with the corresponding modified address elements if a determination is made to replace the editable field data where the replacing comprises replacing the editable field address data if the original street address matches an editable field address data, replacing the editable field city data if the original city matches an editable field city data, replacing the editable field state data if the original state matches an editable field state data, and replacing the editable field zip code data if the original zip code matches an editable field zip code data.

Now referring to FIG. 4, an embodiment of a data entry screen 400 is illustrated. In one embodiment the data entry screen may be a database entry screen. The data entry screen 400 may be implemented a graphical user interface 401, the graphical user interface 401 comprising a plurality of editable fields 402 and a submit button 403. In the illustrated embodiment, original address data elements and modified address data elements may be submitted together.

Now referring to FIG. 5, an embodiment of a data entry screen 500 is illustrated. The data entry screen 500 may be implemented by a graphical user interface 501. Like the data entry screen of FIG. 4, the graphical user interface 501 may comprise a plurality of editable fields 502 and a submit button 503. In the illustrated embodiment, a rule based change may be submitted by the submit rule button 503.

A number of embodiments of the present invention have been described. Nevertheless, it will be understood that various modifications may be made without departing from the spirit and scope of the invention. Other variations relating to implementation of the functions described herein can also be implemented. Accordingly, other embodiments are within the scope of the following claims.

What is claimed is:

1. A method comprising:
storing a plurality of data, the data comprising a plurality of original data elements and corresponding modified data elements;
automatically comparing the plurality of original data elements against editable field data in one or more editable fields displayed on a display screen by an application program.
determining if the editable field data will be replaced; and
replacing the editable field data with the corresponding modified data elements if a determination is made to replace the editable field data.

2. The method of claim 1, wherein the original data elements comprise incorrect address data and the modified data elements comprise corrected address data.

3. The method of claim 1, wherein the application program is a web browser.

4. The method of claim 1, wherein the determining comprises:
comparing the editable field data with the plurality of original data elements;
determining that the editable field data includes original elements that will be replaced by modified elements;

5. The method of claim 1, wherein the determining comprises:
comparing editable field data with the plurality of original data elements;
determining that the editable data fields includes an original element that will be replaced by rule manipulated data;

6. The method of claim 1, further comprising:
receiving a confirmation to replace the editable field data.

7. A system comprising:
a processor; and
a computer readable medium comprising instructions that when executed by the processor perform a method, the method comprising:
storing a plurality of data, the data comprising a plurality of original data elements and corresponding modified data elements;
automatically comparing the plurality of original data elements against editable field data in one or more editable fields displayed on a display screen by an application program.
determining if the editable field data will be replaced; and
replacing the editable field data with the corresponding modified data elements if a determination is made to replace the editable field data.

8. The system of claim 7, wherein the original data elements comprise incorrect address data and the modified data elements comprise corrected address data.

9. The system of claim 7, wherein the application program is a web browser.

10. The system of claim 7, wherein the determining comprises:
comparing the editable field data with the plurality of original data elements;
determining that the editable field data includes original elements that will be replaced by modified elements;

11. A method comprising:
storing a plurality of address data elements, the data elements comprising an original street address, a modified street address, an original city, a modified city, an original state, a modified state, an original zip code, and a modified zip code.
automatically comparing each original address data element against editable field address data in one or more editable address fields displayed on a display screen by an application program, wherein comparing comprises:
comparing the original street address with an editable field address data;
comparing the original city with an editable field city data;
comparing the original state with an editable field state data; and
comparing the original zip code with an editable field zip code data;
determining if the editable field address data will be replaced with the modified address data elements, wherein determining comprises:
determining if the original street address matches an editable field address data;
determining if the original city matches an editable field city data;
determining if the original state matches an editable field state data; and
determining if the original zip code matches an editable field zip code data; and
replacing the editable field address data with the corresponding modified address elements if a determination is made to replace the editable field data wherein the replacing comprises:
replacing the editable field address data if the original street address matches an editable field address data;
replacing the editable field city data if the original city matches an editable field city data;
replacing the editable field state data if the original state matches an editable field state data; and
replacing the editable field zip code data if the original zip code matches an editable field zip code data.

12. The method of claim 10, wherein the application program is a web browser.

13. The method of claim 10, further comprising:
receiving a confirmation to replace the editable field address data.
